(19) United States
(12) Patent Application Publication
(10) Pub. No.: US 2025/0088990 A1
(43) Pub. Date: Mar. 13, 2025

(54) Identifying Timing Advance Command (TAC) Update at User Equipment for Optimizing TA Tracking

(71) Applicant: Parallel Wireless, Inc., Nashua, NH (US)

(72) Inventors: Ori Shmuel, Herzliya (IL); Guy Holtzman, Tel-Aviv (IL); Nimrod Gradus, Givatayim (IL)

(21) Appl. No.: 18/939,442

(22) Filed: Nov. 6, 2024

Related U.S. Application Data
(60) Provisional application No. 63/581,341, filed on Sep. 8, 2023.

(51) Int. Cl. H04W 56/00

(52) U.S. Cl. CPC H04W 56/0045; H04W 56/001

(57) ABSTRACT

A method is disclosed for performing timing advance command (TAC) updates, comprising: configuring an appropriate block error rate (BLER); forwarding a timing advance command (TAC) for a radio network temporary identifier (RNTI) x to a user equipment (UE), the TAC not equal to 31; tracking a time of receipt of a first downlink shared channel (DLSCH) protocol data unit (PDU) with redundancy version (RV) 0 at the user equipment (UE); adding k slots; and continuing tracking timing advance (TA) samples of the radio network temporary identifier (RNTI) x, where k may be based on the subcarrier spacing.

### CROSS-REFERENCE TO RELATED APPLICATIONS

The present application claims priority under 35 U.S.C. § 119 (e) to U.S. Provisional Patent Application No. 63/581,341, filed Sep. 8, 2023 and having the same title as the present application, which provisional patent application is hereby incorporated by reference in its entirety for all purposes.

The present application also incorporates by reference, each in its entirety for all purposes, the following publications: U.S. Patent Publication No. US20200092835A1; U.S. patent application Ser. No. 15/241,060, entitled “Cell ID Disambiguation” and filed Aug. 18, 2016, which itself is a non-provisional conversion of, and claims the benefit of priority under 35 U.S.C. § 119 (e) to U.S. Provisional Pat. App. No. 62/206,666, filed Aug. 18, 2015 with title “Cell ID Disambiguation,” each hereby incorporated by reference in its entirety. As well, U.S. Pat. No. 8,867,418 and U.S. patent application No. 20140133456 are also hereby incorporated by reference in their entireties. The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference, for all purposes, each of the following U.S. Patent Application Publications in their entirety: US20170013513A1; US20170019375A1; US20170026845A1; US20170048710A1; US20170055186A1; US20170064621A1; US20170070436A1; US20170077979A1; US20170111482A1; US20170127409A1. US20170127409A1; US20170171828A1; US20170181119A1; US20170202006A1; US20170208560A1; US20170238278A1; US20170257133A1; US20170272330A1; US20170273134A1; US20170273134A1; US20170288813A1; US20170295510A1; US20170303163A1.

### BACKGROUND

The Timing Advance (TA) is a command used in wireless communication systems to synchronize the uplink transmission timing of individual User Equipment (UEs) with the base station (BS). This is important because the transmission timing of UEs can vary due to factors such as distance, and if not properly aligned, the base station may not be able to correctly receive and process the uplink transmissions.

The overall process of timing advance requires the BS to frequently estimate, per each UE i, what is the propagation delay and send a Timing Advance Command (TAC) if necessary. The BS can rely on periodic and aperiodic transmissions in the UL on the different physical channels to obtain an estimate of the TA. The timing advance mechanism is similar between LTE and NR where the later use different TA steps sizes for different numerologies. Typically, timing-advance commands to a UE are transmitted relatively infrequently—for example, one or a few times per second, but this depends on how fast the UE is moving.

If the UE has not received a timing-advance command during a (configurable) period, the UE assumes it has lost the uplink synchronization. In this case, the device must reestablish uplink timing using the random-access procedure prior to any PUSCH or PUCCH transmission in the uplink.

In FDD (frequency division duplex) the UL frame should be aligned with the DL frame. So, all one needs to set correctly is the TA value for all UEs in the system to have all UL frame arrives at the same time and to align with the DL frame. In TDD (time division duplex), in addition to the TA, one should also consider transceiver switching time of the UEs and BS from DL and UL to set an appropriate guard period.

### SUMMARY

A method is disclosed for performing timing advance command (TAC) updates, comprising: configuring an appropriate block error rate (BLER); forwarding a timing advance command (TAC) for a radio network temporary identifier (RNTI) x to a user equipment (UE), the TAC not equal to 31; tracking a time of receipt of a first downlink shared channel (DLSCH) protocol data unit (PDU) with redundancy version (RV) 0 at the user equipment (UE); adding k slots; and continuing tracking timing advance (TA) samples of the radio network temporary identifier (RNTI) x, where k may be based on the subcarrier spacing.

### BRIEF DESCRIPTION OF THE DRAWINGS

FIG. 1 is a schematic diagram showing a frame offset in a telecommunications system, in accordance with some embodiments.

FIG. 2 is a schematic diagram showing symbol timing in an FDD telecommunications system, in accordance with some embodiments.

FIG. 3 is a schematic diagram showing guard periods in a TDD telecommunications system, in accordance with some embodiments.

FIG. 4 is a schematic diagram showing timing advance prediction, in accordance with some embodiments.

FIG. 5 is a flow diagram showing timing advance prediction, in accordance with some embodiments.

FIG. 6 is a schematic diagram showing radio functional splits, in accordance with some embodiments.

FIG. 7 is an architecture diagram showing an O-RAN compatible deployment architecture for a telecommunications system, in accordance with some embodiments.

FIG. 8 is an architecture diagram showing a multi-RAT deployment architecture for a telecommunications system, in accordance with some embodiments.

### DETAILED DESCRIPTION

This disclosure relates to technology used in wireless communication systems, specifically in the physical layer of the communication stack. In these systems, a TAC (transmission time alignment command) is used at the user equipment (UE) to align the timing of the transmission of data. In some embodiments, the entity that performs this estimation may be the PHY layer and given such estimate the MAC layer control the signaling of the TAC.

The disclosed systems and methods provide a way for the physical layer to be informed when a TAC has been applied at the UE, based on a target BLER (block error rate) and a system target in the downlink transmission. The physical layer can then use this information to optimize the process of tracking the TAC at the eNB/gNB. By knowing the TAC applied on the UE side, eNB/gNB can optimize the transmission and make it more efficient, by reducing errors in the downlink transmission, which can be beneficial for the overall system performance.

This disclosure is applicable to 4G as well as 5G, and it aims to improve the efficiency and performance of the timing advance process for both these generations of systems. The inclusion of this disclosed technique in the 5G and 4G systems will result in an improved user experience by reducing errors in the uplink transmission and increasing the overall capacity of the system.

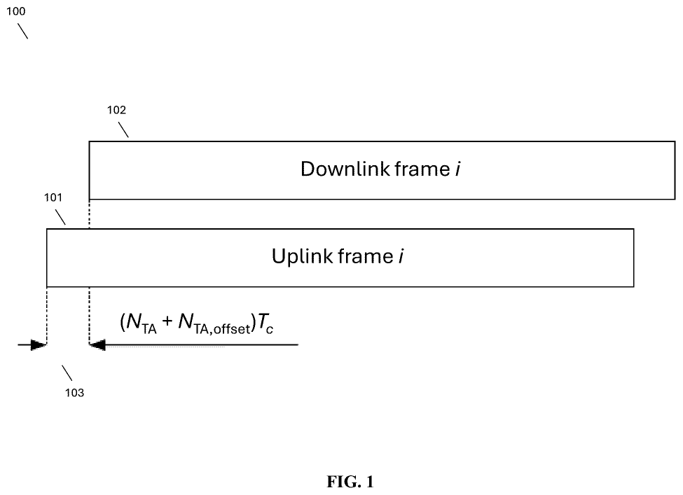

FIG. 1 is a schematic diagram showing a frame offset in a telecommunications system, in accordance with some embodiments. The difference between the uplink frame 101 and the downlink frame 102 is the offset being corrected using the TAC, and that offset is (N_TA+N_TA,offset)T_c.

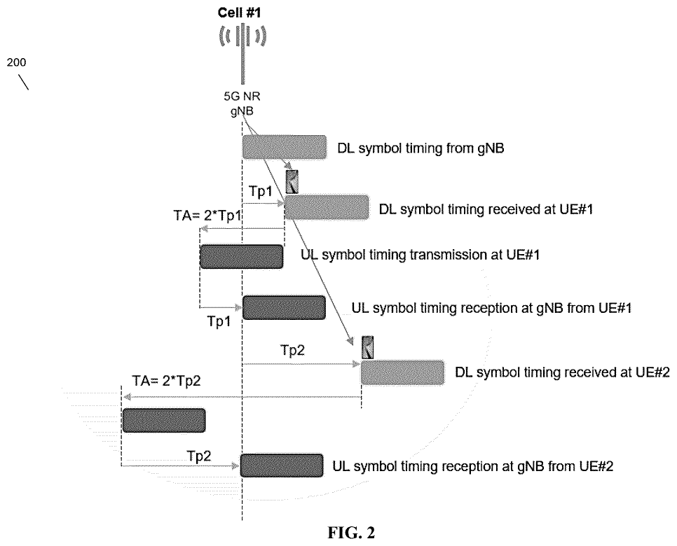

FIG. 2 is a schematic diagram showing symbol timing in an FDD telecommunications system, in accordance with some embodiments. In FDD the UL frame should be aligned with the DL frame. So, all one needs to set correctly is the TA value for all UEs in the system to have all UL frames arrive at the same time and to align with the DL frame. In the figure, 5G NR gNB is shown with two UEs. The gNB sends downlink symbol timing to each of UE 1 and UE 2. UE 1 has timing delay Tp1 and UE 2 has timing delay Tp2. Once the DL symbol timing is received from the gNB at each UE, the each UE changes its symbol timing by twice its individual timing delay, so that after timing advance control, each UE is sending its symbol timing in sync with the gNB.

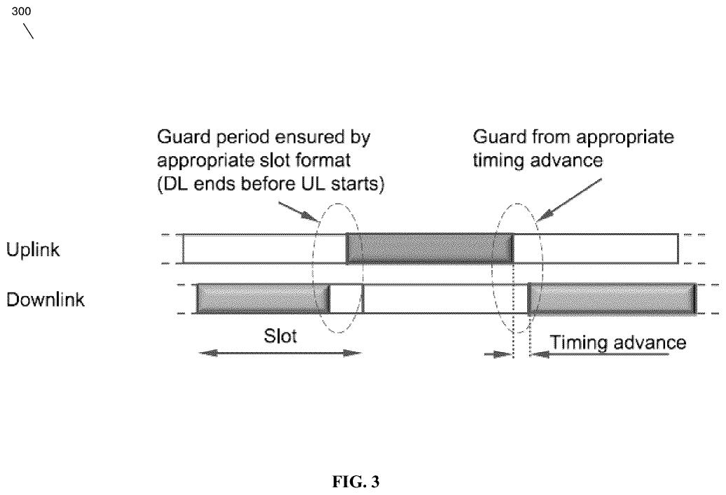

FIG. 3 is a schematic diagram showing guard periods in a TDD telecommunications system, in accordance with some embodiments. In TDD, in addition to the TA, one should also consider transceiver switching time of the UEs and BS from DL and UL to set an appropriate guard period. The guard period is the window of time between the end of the DL slot and the beginning of the UL slot. The guard period can be ensured by the appropriate slot format as well as the appropriate timing measurement and timing advance control.

Once PHY decides to trigger a TAC, it forwards this indication to the MAC layer which is responsible to issue (send) the TAC towards the UE. At this point in time, PHY will want to ignore the TA samples for that UE to avoid a drift in the TA tracking process.

Specific details follow that relate to certain embodiments of the invention.

In the PHY layer, we provide a TA tracking process for RNTIx. As described above, a trigger causes transmission of the alignment message (timing advance command or TAC), so that the UE can be aligned. Any signal between where the UE is unaligned (and we send TAC) and when UE is aligned, we don't want to collect those TA samples, since if we continue to collect samples, we will have drift.

The issue being addressed here is determining when the PHY layer should stop using TA samples for a specific UE and when to begin again using them. Alternatively, when will the UE will employ the TAC once a decision to issue it was taken. The timing for this is not fixed, as it can be affected by various factors such as the scheduling of transmissions and other dynamic elements in the system.

By knowing the exact time when the TAC is issued, the tracking process can be adjusted to reflect the updated TA value and continue to gather statistics based on this new value. This approach can improve the performance of the timing advance process in situations where the UEs are highly mobile, as it would allow for more accurate tracking and adjustments to be made.

The problem is that we don't know when the UE has corrected its time alignment. Depends on when the command has been received. Once received, the 3GPP spec is explicit about the number of slots that can elapse between when the command is received and when the alignment is achieved.

We describe a method for PHY to identify the transmission of TAC and to determine the time the UE will employ the TAC in case of successful decoding at the UE. Assuming a certain target BLER (e.g., 10%) we get an acceptable estimation to when the PHY can return and collect TA samples for the UE by suffering a drift at the rate of the system target BLER.

The method is when to identify when the UE has really got the TAC message, without a proprietary indicator between the stack and the PHY letting to know when the UE got the TAC command. We can do it without changing the API between MAC and PHY. We can do it having the PHY not knowing what happens in the MAC layer. The PHY identifies by itself the random time. To be general, we don't care about the first two blue lines (TAC processing time by stack; and, time in queue). But, the disclosure involves appreciating that the DLSCH PDU with RNTI x with RV 0 (it is a new allocation) will include the TAC. We wait for a PDSCH which is not a retransmission, plus k slots. At that point, we can assume with high probability (˜90%) that the UE has updated its TA. This method is enabled by controlling the prioritization at the gNB scheduler, namely, by causing the scheduler to prioritize the TAC command before everything (prioritizing retransmission first). TAC is prioritized because time alignment is very high priority. This is not the case in the prior art, where other schedulers cannot send the retransmission and send the TAC immediately.

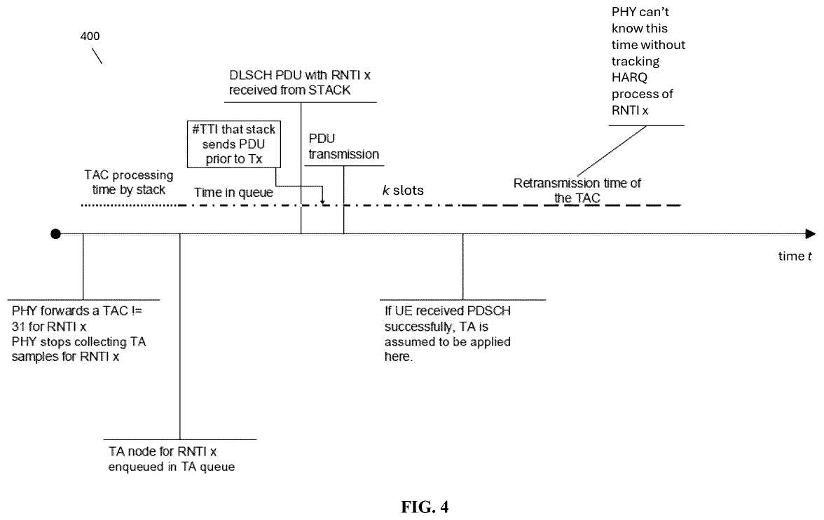

FIG. 4 is a schematic diagram showing timing advance prediction, in accordance with some embodiments.

Assume PHY identifies it needs to send a TAC, PHY forwards the TAC and stops collecting TA sample for RNTI x. Assuming the TAC processing time by stack is known (or negligible), from that point in time one can assume that the first DLSCH PDU with RV 0, since retransmissions can't change payload, will include the TAC. Thus, PHY knows the PDU transmission time. If the non-retransmit transmission is received at the UE, after k slots PHY can continue tracking TA samples of RNTI x. These time intervals are depicted in the figure below. This method can be used to determine the time the UE will deploy the TAC.

Restated differently, PHY is triggered and forwards a TAC!=31 message. Then, TAC processing time by stack. A few slots (roughly 1-2 ms). Then, time in queue.

The k slots mentioned above are defined by 3GPP. Specifically, k=[N_slot\hat{ }(sub frame,μ)·((N_(T,1)+N_(T,2)+N_(TA,max)+0.5))/T_sf] where the variables description can be found in 3GPP TS 38.213 section 4.2 and elsewhere in the document, TS 38.211, TS. 38.214, TS 38.321, and other such documents, each hereby incorporated by reference.

For subcarrier spacing (SCS) of 30 KHz, k=5. That is, it takes the UE 6 slots to apply the TAC (as shown in the figure). k will be the same for all UEs in the cell. Where 4G numerology is used, an appropriate value of u is selected.

One possibility without doing this method could be a timeout. But that would be undesirable because it would be slower. Unlike this case which has 90% correctness. Another possibility could be to wait for the UE to send a response to the timing advance command. More accurate with respect to the when of which the user has applied his correction. But suppose we are using a backoff timer and we have to wait 30 slots to be on the safe side, instead of 6 slots. It will vary because we don't know when the PDU will arrive.

If stochastic, the PHY has to wait for the time. If deterministic, the PHY can assume it based on only one one variable, the amount of processing time needed for MAC to process the TAC request. For a loaded system the time in queue can vary. Time in queue is stochastic and we don't care about. But any fixed backoff needs to be more than the stochastic queue time. In the deterministic case it allows the stack to advantageously only check the RNTI x and look for RV 0.

In some embodiments the BLER is preconfigured; in other embodiments the BLER can be measured from a different part of the system and can be fitted to the specific UE or cell.

Uplink signals PHY is performing TA estimation, e.g., how late or not late the time alignment is TA is used to align the UE with the base station. If there is a user who is close and a user who is far, the signal will be received at a different time. We need to correct each one according to its own propagation delay.

For FDD it is contemplated to do this by switching between UL and DL and vice versa. Both in FDD and TDD a UE transmits prior to the DL slot. In TDD, a guard period should be set in addition and an additional N_(TA,offset) is introduced.

If we know the average time in the queue that is sufficient for most cases.

Once PHY decides to trigger a TAC, it forwards the request to the MAC layer.

In our application it is ˜6 slots from the moment we send it to the air. In the spec it is disclosed for k slots.

What if the user doesn't get this DL message, due to errors etc? We handle this by assuming that 10% of messages will be unsuccessful (e.g., 10% BLER).

If we know 90% of the time that the UE has gotten the TAC message, that is adequate.

If the PHY doesn't know these times, because it is not able to know if there was a PDU for RNTIx that includes this TAC command, then every slot, we need to give the UE an allocation and send him a PDU for DLSCH. And every time we send a PDU it is with RV-0. If we do not know these times we will not be able to identify which of these PDUs includes the TAC command.

TA mechanism is similar between LTE and 5G NR; the latter use different TA steps sizes for different numerologies. So this method could be used for 5G NR as well.

Typically, TACs are transmitted relatively infrequently one or a few times per second, depends on UE speed. If configured, an unreceived TAC will trigger a reestablishment process (RACH) by the UE.

TA commands units & CE. TAC MAC CE is identified (signaled) by MAC sub header with LCID 61 (table 6.2.1.-1 38.321). This command occupies 6 bits in the MAC CE. The regular MAC CE can indicate a value between T_A={0, 1, . . . , 63}. The initial TAC is sent in the MSG2 (RAR), and it occupies 12 bits. The MAC RAR can indicate a value between T_A={0, 1, . . . , 3846}

$$The calculation of T\_ ( TA , i ) is : T\_ ( TA , i ) = ( N\_TA + N\_ ( TA , offset ) ) \cdot T\_c$$

Where,
N_(TA,offset) is provided to the UE in RRC configurations (SIB1)
The value can be 0, 25600, or 39936 for FR1.
The default value of N_(TA, offset) is set as 25600 for FR1.
For FR2, the value is fixed at 13792.
N_(TA,offset) is defined in Table 7.1.2-2 of TS 38.133.
This offset is translated to roughly 13 [μs].

### TA Estimation

TA estimation is done by estimating phase shift of a known signal received at the BS. DMRSs that exist in the PUSCH and PUCCH (in some formats); SRS; RA preamble. Like any estimation, TA estimation suffer from estimation error especially when the length of the signal is short (data points). However, with sufficient data points we can promise sufficient accuracy and design the TA estimation process accordingly.

### TA Handling in MAC

### Current Parameters:

TaAveragingFactor—the coefficient for an IIR filter done on every TA sample received from PHY. TaSyncTimerDelta—a time interval which is taken back from the RRC configured value TimeAlignmentTimer in the TAG-Config IE for which a TAC is triggered to be send in the next opportunity for this UE. This process is denoted as ‘keepalive’ sync.

One method for TA handling in the STACK (MAC) is below. The MAC maintains two queues, namely, the NEW_TA queue and the TA_FAILURE queue. Once a TAC is triggered due to either a change in TA or as part of ‘keepalive’ sync, if there is no existing TAC in the NEW_TA queue, a new queue node is generated and enqueued into the NEW_TA queue. In case that a TAC has failed due to PDCCH or PDSCH allocation error the node is moved from the NEW_TA queue to the TA_FAILURE queue.

The scheduler prioritize his transmission in the following order:

DL Retransmission Queue. Failure TA Queue. New TA Queue. New Transmission. When processing TA queues. If UE was already scheduled for data, a TAC is added to the transmission. If UE was not scheduled for data and has a pending TAC he might be scheduled with or without data (depending on Qload state—the details are not clear). For every successful CRC INDICATION PDU received from PHY, stack process the TA sample (if it is valid-less than 64). TA sample is IIR filtered. If the current sample and the averaged TA not equal to 31 a TAC is triggered by adding a TA node for this UE into the NEW_TA queue. If additional TA sample arrives for this UE the TAC is updated if it is in the TA_FAILURE queue.

In some cases the PHY may need to know that a certain RNTI is no longer available. They have aging mechanism and UE context is used also for other purposes. MAC might need to notify PHY the TA is scheduled. The present disclosure describes an appropriate method to determine TAC transmission. CSI might not be reported all the time; this method will support TA estimation without periodic CSI reports.

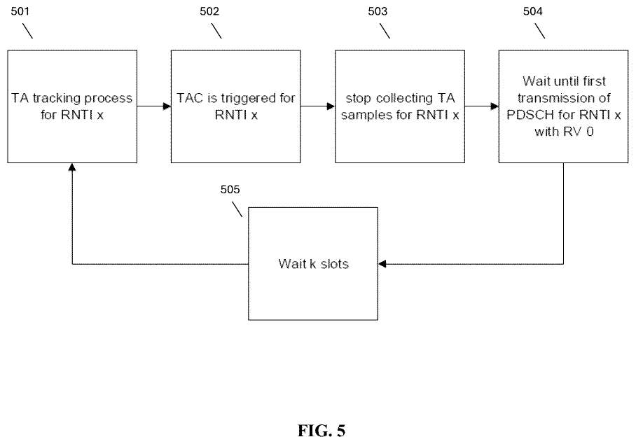

FIG. 5 shows a flow diagram of a TA tracking process, at a base station, in some embodiments. At 501, a TA tracking process is initiated for a particular UE (RNTI x). At 502, the TAC is triggered for RNTI x, which includes beginning to collect TA samples for RNTI x. At 503, the TA tracking process stops collecting TA samples for RNTI x. At 504, the TA tracking process waits until first transmission of PDSCH for RNTI x with RV 0. At 505, the TA tracking process waits an additional k slots based on scheduler priority timing as discussed herein. After waiting k slots, the TA tracking process is complete. The TA tracking process may be resumed and continued with execution returning to 501, in some embodiments.

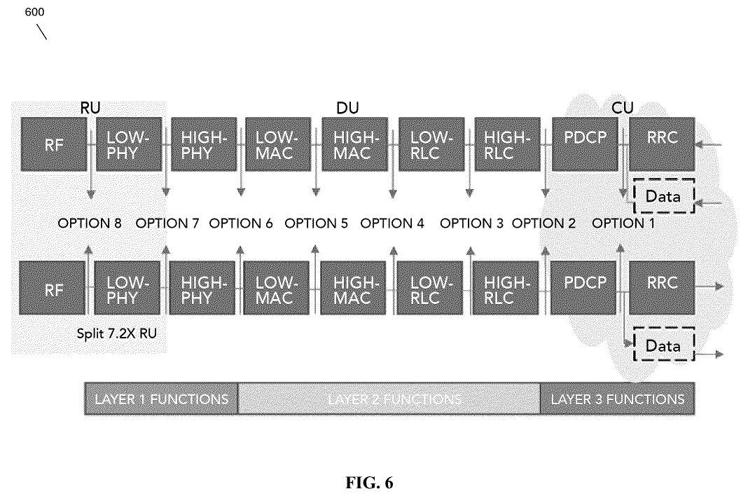

FIG. 6 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

When the RAN functional split architecture (FIG. 42) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety.

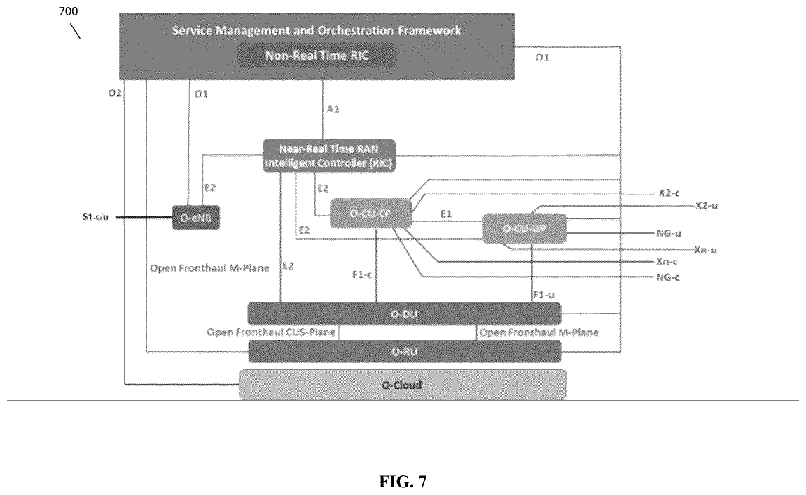

FIG. 7 is a schematic diagram of an Open RAN 4G/5G deployment architecture, as known in the prior art. The O-RAN deployment architecture includes an O-DU and O-RU, as described above with respect to FIG. 40, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU. The present application describes network agility; this is also missing from the ORAN network concept.

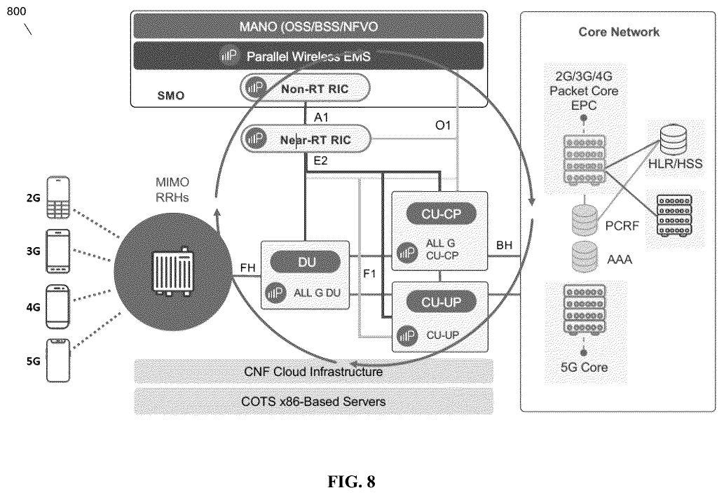

FIG. 8 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G. In some embodiments, the near-RT RIC may perform the functions described herein as performed by the eNB/gNB and share the results of those functions with the eNB/gNB.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for performing timing advance command (TAC) updates, comprising:
configuring an appropriate BLER;
forwarding a TAC for RNTI x to a UE, the TAC!=31;
tracking the time of receipt of the first DLSCH PDU with RV 0 at the UE;
adding k slots; and
continuing tracking TA samples of RNTI x,
where k is defined as above in the present disclosure and is based on the subcarrier spacing.

2. A method for performing timing advance command (TAC) updates, comprising:
configuring an appropriate block error rate (BLER);
forwarding a timing advance command (TAC) for a radio network temporary identifier (RNTI) x to a user equipment (UE), the TAC not equal to 31;
tracking a time of receipt of a first downlink shared channel (DLSCH) protocol data unit (PDU) with redundancy version (RV) 0 at the user equipment (UE);
adding k slots; and
continuing tracking timing advance (TA) samples of the radio network temporary identifier (RNTI) x,
where k is based on the subcarrier spacing.
